(19) United States
(12) Patent Application Publication
(10) Pub. No.: US 2007/0035525 A1
(43) Pub. Date: Feb. 15, 2007

(54) Integrated touch screen control system for automobiles

(75) Inventors: Iang-Chi Yeh, Jhongli City (TW); Jen-Tien Chiang, Taipei City (TW); Chi-Ming Sung, Taipei (TW)

Correspondence Address: Howard Chen;Preston Gates & Ellis LLP, Suite 1700, 55 Second Street, San Francisco, CA, 94105, US

(73) Assignee: VIA Technologies, Inc.

(21) Appl. No.: 11/201,911

(22) Filed: Aug. 11, 2005

(51) Int. Cl. G09G 5/00

(52) U.S. Cl. 345/173

(57) ABSTRACT

The present invention discloses an integrated touch screen control system implemented in an automobile. The touch screen control system includes a touch screen device having a pressure sensitive screen for converting at least one pressured point thereon into at least one control signal representing a location thereof. A controlled device structurally separated from the touch screen device performs at least one predetermined function in response to the control signal. Interfacing means is eclectically or optically coupled between the touch screen device and the controlled device for sending the control signal from the touch screen device to the controlled device.

### BACKGROUND

The present invention relates to electronic apparatuses, and more particularly to an integrated touch screen control system used in automobiles.

As technology continues to improve in the automobile industry, it is common for an automobile to be equipped with an entertainment system, such as a DVD player. It is also common for the automobile to have a touch screen device, which is able to detect a selection signal from a user based on a physical pressure applied to the display. Such touch screen device typically provides functions, such as road guidance and automatic control. For example, the driver can directly touch at a preprogrammed option that is displayed to make a selection with respect to environmental conditioning, as opposed to juggling with various knobs and buttons that are typically necessary to change a combination of automobile temperature, fan speed, etc. This simplicity allows the driver to pay more attention to the road for safety reasons.

However, even with both the DVD player and the touch screen device widely available for automobiles, they are not yet integrated together. While most DVD players come with a remote control, it is still inconvenient to be used in the automobile. Since there is already a touch screen device available in many automobiles, it is desirable to integrate the touch screen device with the DVD player, so that it can be easily controlled by the touch screen device.

### SUMMARY

The present invention discloses an integrated touch screen control system implemented in an automobile. The touch screen control system includes a touch screen device having a pressure sensitive screen for converting at least one pressured point thereon into at least one control signal representing a location thereof. A controlled device structurally separated from the touch screen device performs at least one predetermined function in response to the control signal. Interfacing means is eclectically or optically coupled between the touch screen device and the controlled device for sending the control signal from the touch screen device to the controlled device.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates a block diagram showing an integrated touch screen control system used in automobiles in accordance with one embodiment of the present invention.

FIG. 2A illustrates a block diagram showing an integrated touch screen control system with an infrared (IR) based interfacing means in accordance with another embodiment of the present invention.

FIG. 2B illustrates a signal format used by the integrated touch screen control system in accordance with the embodiment of the present invention.

FIG. 3 illustrates a block diagram showing an integrated drive electronics (IDE) protocol based interfacing means used in the integrated touch screen control system in accordance with another embodiment of the present invention.

FIG. 4 illustrates a block diagram showing an integrated touch screen control system with a memory and control device in accordance with another embodiment of the present invention.

FIG. 5 illustrates a block diagram showing an integrated touch screen control system with a switch circuit and a color-video-blanking-and-sync (CVBS) device in accordance with another embodiment of the present invention.

### DESCRIPTION

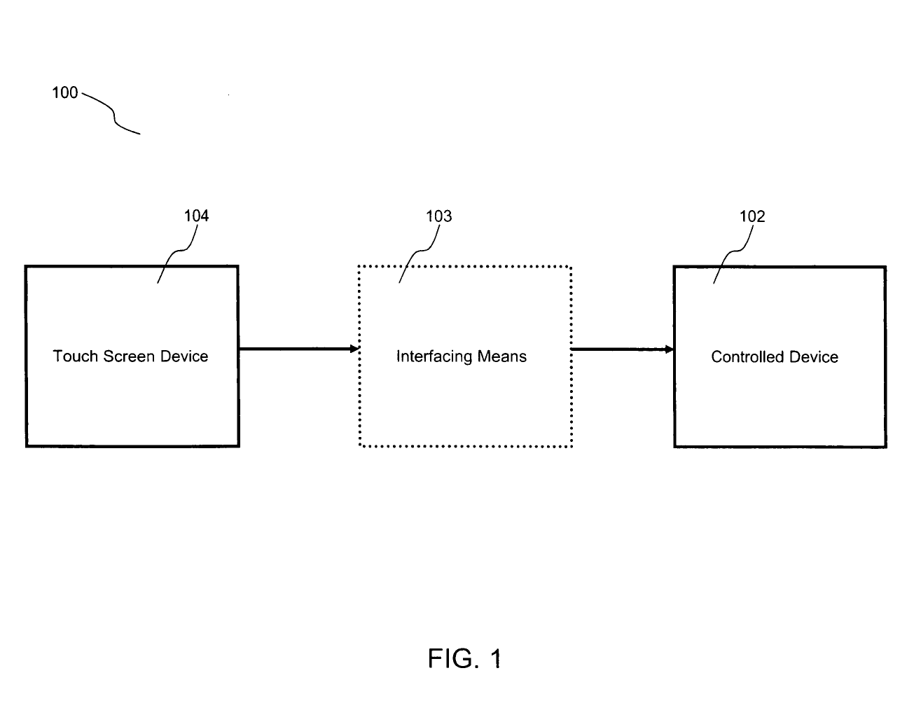

FIG. 1 illustrates a block diagram showing an integrated touch screen control system 100 used in automobiles in accordance with one embodiment of the present invention. The touch screen control system 100 includes a touch screen device 104 and a controlled device 102, which are connected by interfacing means 103. The touch screen device 104 has a pressure sensitive screen (not shown in the figure) for converting a pressured point thereon into a control signal that represents the pressured point's location. The controlled device 102, which is structurally separated from the touch screen device 104, is electrically or optically connected to the same via the interfacing means 103. The interfacing means 103 receives the control signal from the touch screen device 104 and then sends it to the controlled device 102, which performs a predetermined function in response to the signal. The controlled device 102 can be a DVD player, VCD player, VCR, TV set, CD player, cassette player or other electronic devices that can be used in automobiles. The interfacing means 103 is illustrated in dashed lines since it can be a standalone device or components built in the touch screen device 104 and the controlled device 102.

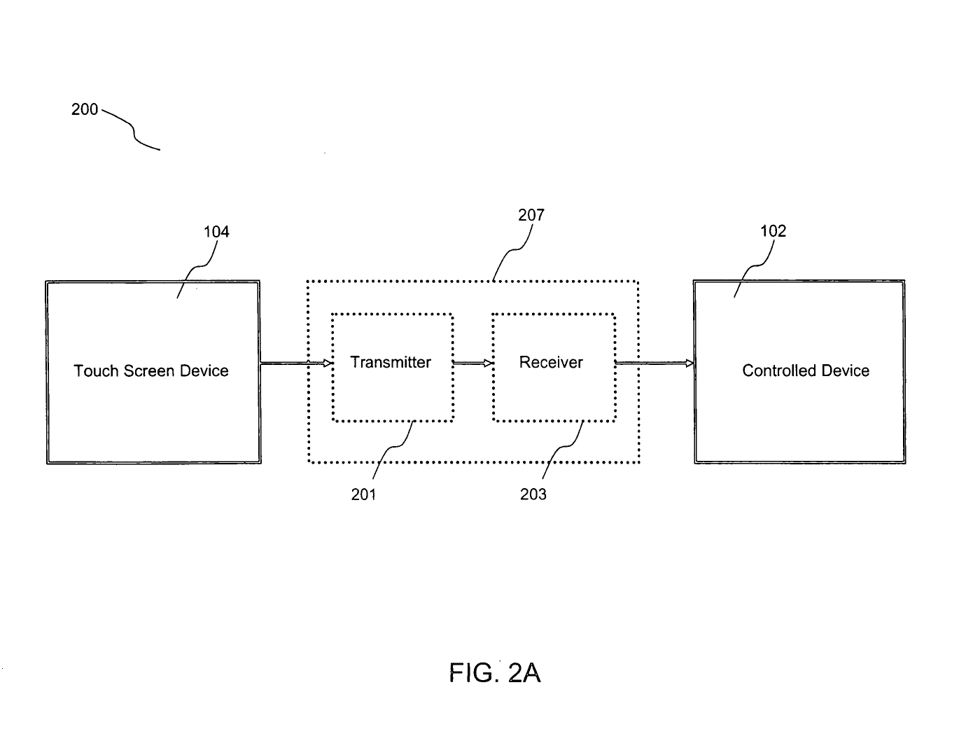

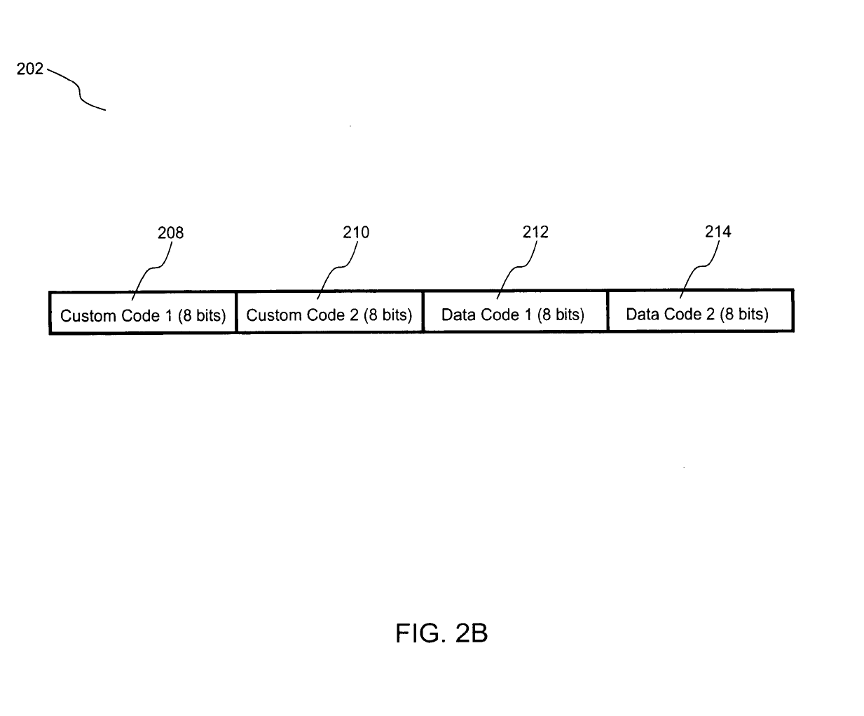

FIG. 2A illustrates a block diagram showing an integrated touch screen control system 200 with an infrared (IR) based interfacing means 207 in accordance with another embodiment of the present invention. The integrated touch screen control system 200 includes a touch screen device 104 coupled to a controlled device 102 through an interfacing means 207. The touch screen device 104 and controlled device 102 are similar to those illustrated in FIG. 1. The interfacing means 207 includes a transmitter 201 coupled with the touch screen device 104 for transmitting the control signal generated therefrom. In this embodiment, the transmitter 201 sends out the control signal using IR as carrier waves. The receiver 203, which is coupled to the controlled device 102, receives the control signal from the transmitter 201 and sends it to the same. The controlled device 102 then performs a certain function in response to the control signal. It is noted that while the transmitter 201 and receiver 203 are parts of the interfacing means 207 in a functional point of view, they can be components physically built in the touch screen device 104 and the controlled device 102, respectively.

FIG. 2B illustrates an exemplary signal format 202 used by the integrated touch screen control system 200 as shown in FIG. 2A. Each control signal 202 has at least 32 bits, including two 8-bit custom codes 208 and 210, and two 8-bit data codes 212 and 214. The custom codes 208 and 210 are used for identifying the type of equipment, such as a DVD player, VCD player, VCR, TV set, CD player, cassette player or other devices. The data codes 212 and 214 are designed for coding a specific function the controlled device 102 (shown in FIG. 2A) may perform. For example, considering the controlled device 102 being a DVD player, the functions can be play, skip-forward, skip-backward, pause, etc. Each function is programmed into a specific control signal which requires a unique combination of custom codes and data codes. For example, a custom code for selecting a TV as the equipment is “01” and a data code used for selecting the power-on function is “046.” Such custom codes and data codes are generic and are used by many brands of devices today.

To allow a user to select such functions straight from the touch screen device 104 (shown in FIG. 2A), the control signal must be able to represent a set of X coordinates and Y coordinates. Representing the X coordinate and Y coordinate of the location of a pressured point may require two control signals. To further illustrate, one control signal is for representing the X coordinate, and the other control signal is for representing the Y coordinate. For example, when the 8-bit custom code 208 is programmed with a hex-numeral of “01” and the 8-bit custom code 210 is programmed with a hex-numeral of “FE,” it means that the data codes 212 and 214 are used to represent X coordinates. The 8-bit data code 212 contains a most significant bit (MSB) of a particular X coordinate, while the set of 8-bit data code 214 contains a least significant bit (LSB) of the particular X coordinate. The Y coordinates are transmitted in a similar fashion. For example, when the 8-bit custom code 208 is programmed with a hex-numeral of “02” and the 8-bit custom code 210 is programmed with a hex-numeral of “FD,” it means that the data codes 212 and 214 are used to represent Y coordinates. The 8-bit data code 212 contains a most significant bit (MSB) of a particular Y coordinate, while the 8-bit data code 214 contains a least significant bit (LSB) of the particular Y coordinate.

Alternatively, the control signal can also be sent and received by using an RC5 or NEC remote control protocol instead of the above described formats. The NEC protocol uses the pulse distance to encode a signal. The RC5 protocol is characterized by a bi-phase coding method, meaning that a logic “1” is transmitted as a half-bit time with a “0” signal, followed by a half bit time with a “1” signal while a logic “0” has an exact opposite structure. For example, if a bit is to be set as high or “1,” the signal within the bit would jump from “0” to “1” at the half-bit time. If a bit is to be set as low or “0,” the signal within the bit would jump from “1” to “0” at half-bit time. A typical RC5 format control signal includes a 14-bit signal in a structure where there are two run-in bits, a check bit or control bit used for toggling purposes, five system address bits, and six command bits. The system address bits are used for selecting the type of equipment that is being controlled while the command bits are used for providing the selected function.

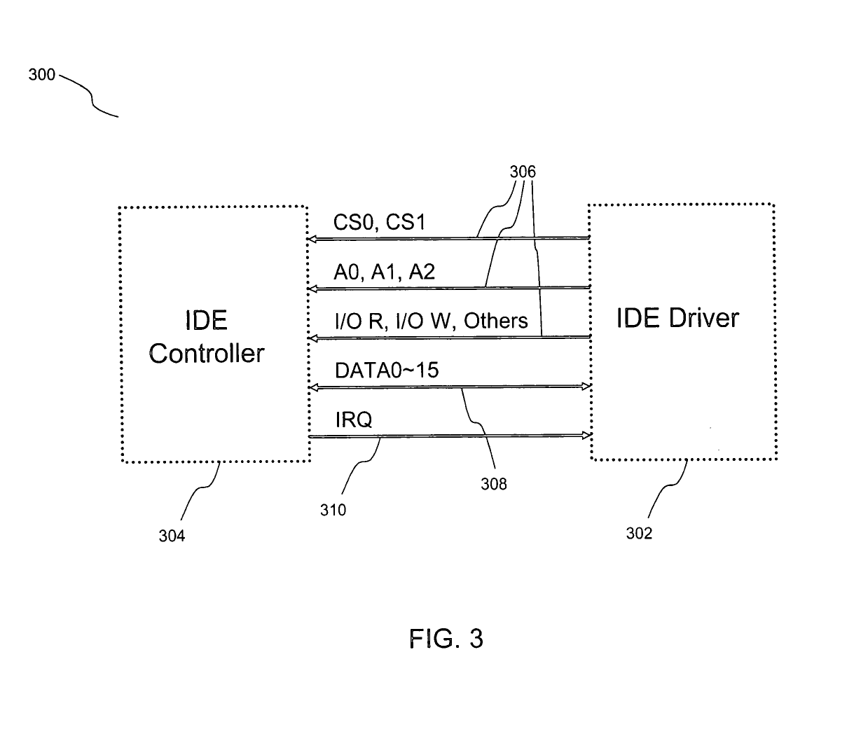

FIG. 3 illustrates a block diagram showing an interfacing means 300 for the touch screen device 104 and the controlled device 102 (shown in FIG. 1) in accordance with another embodiment of the present invention. The interfacing means 300 includes an integrated drive electronics (IDE) controller 304 and an IDE driver 302, between which data are transmitted through conductive lines by using an IDE protocol. The IDE controller 304 is coupled to or built in the controlled device 104, and the IDE driver 302 is coupled to or built in the touch screen device 104. The interfacing means 300 provides an alternative scheme of transmitting the control signal between the controlled device 102 and the touch screen device 104. In this embodiment, the control signal includes custom codes 306, and a 16-bit data code 308. In the example shown, the custom code 306 includes two control select bits (CS0, CS1), three address code bits (A0, A1, A2), and multiple bits used for read and write operations (IOR, IOW, others). The data code bits (DATA˜15) 308 and the interrupt code (IRQ) 310 are also available for the IDE device 304 and IDE driver 302.

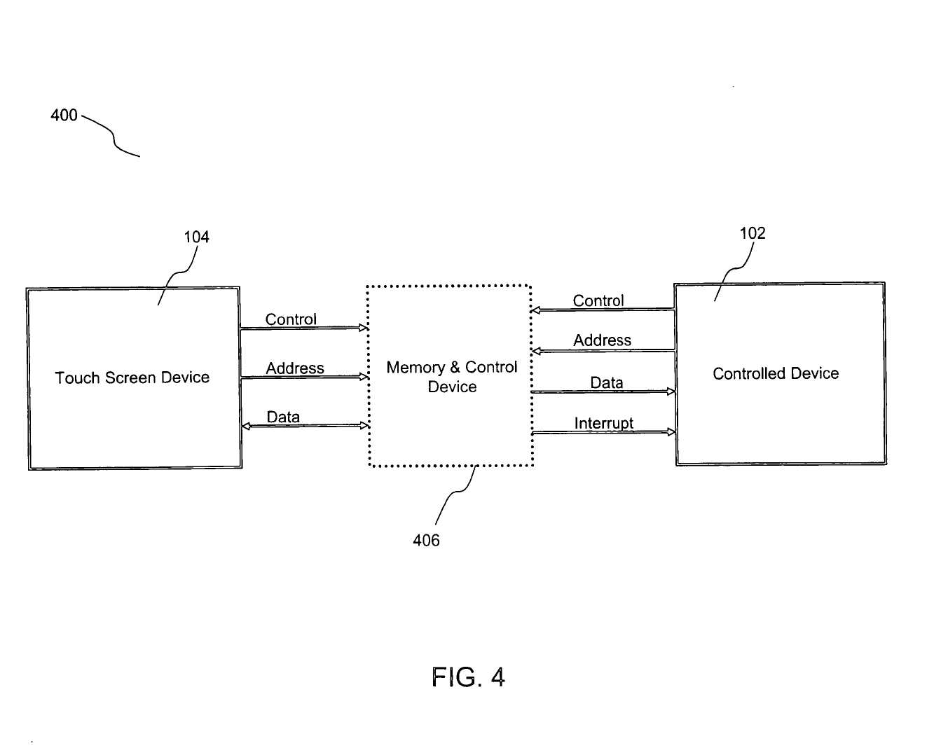

FIG. 4 illustrates a block diagram showing an integrated touch screen control system 400 in accordance with another embodiment of the present invention. The integrated touch screen control system 400 includes a memory and control device 406 coupled between a touch screen device 104 and a controlled device 102, which are similar to those shown in FIG. 1. The memory and control device 406 has one or more pins for receiving control commands, address bits and data bits from the touch screen device 104. The memory and control device 406 also receives control commands and address bits from the controlled device, and outputs data bits and an interrupt signal to the same. The data bits, which represent the control signal generated by the touch screen device 104, are saved in the memory and control device 406 for being retrieved by the controlled device 102.

There are some schemes that can be used by the controlled device 102 to retrieve the data bits stored in the memory and control device 406. One of the schemes is to have the controlled device 102 proactively check the memory and control device 406 for retrieving the data bits stored therein at a predetermined frequency. Another scheme is that the memory and control device 406 outputs an interrupt signal to the controlled device, when a control signal generated by the touch screen device 104 is saved as data bits therein. The controlled device 102 then retrieves the data bits from the memory and control device 406 in response to the interrupt signal.

It is noted that while the memory and control device 406 can be a standalone device coupled between the touch screen device 104 and the controlled device 102, it can also be a component built in the touch screen device 104 or the controlled device 102.

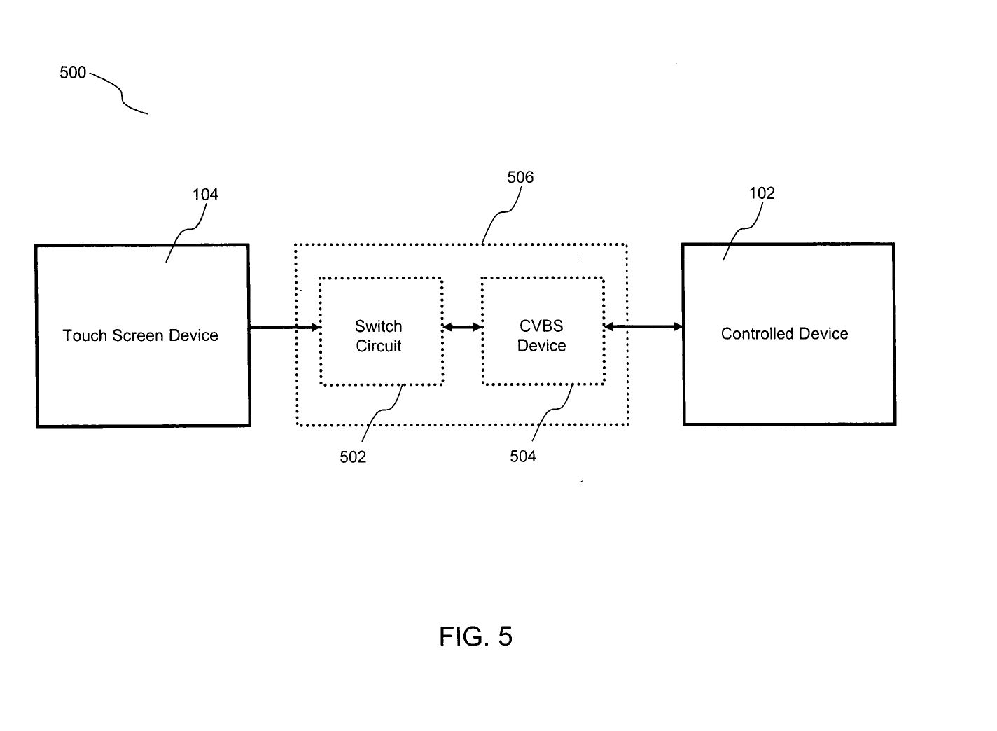

FIG. 5 illustrates a block diagram showing an integrated touch screen control system 500 in accordance with another embodiment of the present invention. The integrated touch screen control system 500 includes a touch screen control device 104 coupled to a controlled device 102 through interfacing means 506. The touch screen device 104 and the controlled device 102 are similar to those shown in FIG. 1. The interfacing means 506 includes a switch circuit 502 coupled to the touch screen device 104, and a CVBS device 504 coupled between the switch circuit 502 and the controlled device 102. The switch circuit 502 has one or more switch states representing various control signals generated by the touch screen device 104. It is understood that a typical CVBS connector has a function of detecting if a device at the signal output end is outputting any signal. The CVBS device 504 utilizes this function to detect the switch circuit 502 for the switch states, and then outputting the control signal to the controlled device 102.

It is noted that while the switch circuit 502 and the CVBS device 504 can be a standalone device coupled between the touch screen device 104 and the controlled device 102, it can also be components built in the touch screen device 104 or the controlled device 102.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. An integrated touch screen control system implemented in an automobile, comprising:
a touch screen device having a pressure sensitive screen for converting at least one pressured point thereon into at least one control signal representing a location thereof;
a controlled device structurally separated from the touch screen device for performing at least one predetermined function in response to the control signal; and
interfacing means eclectically or optically coupled between the touch screen device and the controlled device for sending the control signal from the touch screen device to the controlled device.

2. The integrated touch screen control system of claim 1 wherein the controlled device is a DVD player, VCD player, VCR, TV set, CD player or cassette player.

3. The integrated touch screen control system of claim 1 wherein the interfacing means comprises a transmitter coupled to the touch screen device for transmitting the control signal and a receiver coupled to the controlled device for receiving the control signal.

4. The integrated touch screen control system of claim 3 wherein the control signal is carrier by infrared waves.

5. The integrated touch screen control system of claim 3 wherein the control signal comprises at least 32 bits, including at least two 8-bit custom codes for identifying the controlled device, and at least two 8-bit data codes for representing coordinates of the pressured point.

6. The integrated touch screen control system of claim 3 wherein the control signal is sent and received by using an RC5 or NEC remote control protocol.

7. The integrated touch screen control system of claim 1 wherein the interfacing means comprises an IDE driver coupled to the touch screen device for sending the control signal to an IDE controller coupled to the controlled device, using an IDE protocol.

8. The integrated touch screen control system of claim 7 wherein the touch screen device and the IDE controller are connected by a plurality of conductive lines for carrying one or more control select commands, address bits, I/O commands, data bits and interrupt request commands.

9. The integrated touch screen control system of claim 1 wherein the interfacing means comprises a memory and control device coupled between the touch screen device and the controlled device for storing the control signal therein.

10. The integrated touch screen control system of claim 9 wherein the controlled device proactively checks the memory and control device for retrieving the control signal stored therein at a predetermined frequency.

11. The integrated touch screen control system of claim 9 wherein the controlled device retrieves the control signal from the memory and control device in response to an interruption signal received therefrom.

12. The integrated touch screen control system of claim 1 wherein the interfacing means comprises a switch circuit coupled to the touch screen device, having at least one switch state representing the control signal.

13. The integrated touch screen control system of claim 12 wherein the interfacing means further comprises a CVBS device coupled between the controlled device and the switch circuit for detecting the switch state of the switch circuit for outputting the control signal to the controlled device.

14. An integrated touch screen control system implemented in an automobile, comprising:
a touch screen device having a pressure sensitive screen for converting at least one pressured point thereon into at least one control signal representing a location thereof;
a controlled device structurally separated from the touch screen device for performing at least one predetermined function in response to the control signal; and
interfacing means eclectically or optically coupled between the touch screen device and the controlled device for sending the control signal from the touch screen device to the controlled device by using infrared carrier waves.

15. The integrated touch screen control system of claim 14 wherein the controlled device is a DVD player, VCD player, VCR, TV set, CD player or cassette player.

16. The integrated touch screen control system of claim 15 wherein the interfacing means comprises a transmitter coupled to the touch screen device for transmitting the control signal and a receiver coupled to the controlled device for receiving the control signal.

17. The integrated touch screen control system of claim 14 wherein the control signal comprises at least 32 bits, including at least two 8-bit custom codes for identifying the controlled device, and at least two 8-bit data codes for representing coordinates of the pressured point.

18. The integrated touch screen control system of claim 14 wherein the control signal is sent and received by using an RC5 or NEC remote control protocol.

19. An integrated touch screen control system implemented in an automobile, comprising:
a touch screen device having a pressure sensitive screen for converting at least one pressured point thereon into at least one control signal representing a location thereof;
a controlled device structurally separated from the touch screen device for performing at least one predetermined function in response to the control signal; and
interfacing means eclectically or optically coupled between the touch screen device and the controlled device for sending the control signal from the touch screen device to the controlled device by using one or more conductive lines.

20. The integrated touch screen control system of claim 19 wherein the interfacing means comprises an IDE driver coupled to the touch screen device for sending the control signal to an IDE controller coupled to the controlled device, using an IDE protocol.

21. The integrated touch screen control system of claim 20 wherein the touch screen device and the IDE controller are connected by a plurality of conductive lines for carrying one or more control select commands, address bits, I/O commands, data bits or interrupt request commands.

22. The integrated touch screen control system of claim 19 wherein the interfacing means comprises a memory and control device coupled between the touch screen device and the controlled device for storing the control signal therein.

23. The integrated touch screen control system of claim 22 wherein the controlled device proactively checks the memory and control device for retrieving the control signal stored therein at a predetermined frequency.

24. The integrated touch screen control system of claim 22 wherein the controlled device retrieves the control signal from the memory and control device in response to an interruption signal received therefrom.

25. The integrated touch screen control system of claim 19 wherein the interfacing means comprises a switch circuit coupled to the touch screen device, having at least one switch state representing the control signal.

26. The integrated touch screen control system of claim 25 wherein the interfacing means further comprises a CVBS device coupled between the controlled device and the switch circuit for detecting the switch state of the switch circuit for outputting the control signal to the controlled device.
